(19) United States
(12) Patent Application Publication
(10) Pub. No.: US 2011/0242002 A1
(43) Pub. Date: Oct. 6, 2011

(54) HAND-HELD DEVICE WITH A TOUCH SCREEN AND A TOUCH STRIP

(76) Inventors: Jonathan KAPLAN, San Francisco, CA (US); John Furlan, Belmont, CA (US); Ariel Braunstein, San Francisco, CA (US); Simon Fleming-Wood, Oakland, CA (US); Richard Tobias Inman, San Francisco, CA (US); Greg Allen Cummings, San Francisco, CA (US); Elizabeth A. Cleary, San Francisco, CA (US); Ryan Devenish, San Francisco, CA (US); Michael Jones, San Francisco, CA (US); Matthew John Barthelemy, Palo Alto, CA (US)

(21) Appl. No.: 12/750,549

(22) Filed: Mar. 30, 2010

(51) Int. Cl. G06F 3/041

(52) U.S. Cl. 345/173

(57) ABSTRACT

A computing device that includes a display configured to display a first video and a touch strip configured to receive user input. The computing device further includes a processor and a memory storing instructions that when executed by the processor cause the processor to determine that the user input comprises a drag input defined by sliding at least one finger along the touch strip, and, in response to the drag input, cause a second video to be displayed on the display.

### BACKGROUND

1. Field of the Invention

The present invention relates generally to hand-held devices and, more specifically, to a hand-held device with a touch screen and a touch strip.

2. Description of the Related Art

Consumer device technology has developed rapidly over the past decade. A broad variety of consumer devices are now available to meet the diverse needs of a wide spectrum of consumers. An example of a consumer device is a digital video camcorder (DVC) that provides a user with a convenient device that records video and audio and also provides the ability to transfer the recorded video and audio to a computer-readable medium. The computer-readable medium may be, for example, a Digital Video Disc (DVD) or a computer memory.

Many DVCs include an internal memory that allows videos and/or photos to be stored within the DVC. The DVC also typically includes a display that allows the stored videos and/or photos to be played back to the user. However, many conventional user interfaces, and user input techniques, are cumbersome and difficult to navigate for the average user.

Accordingly, there remains a need in the art for an improved user interface and associated user input techniques that overcome the problems associated with conventional approaches.

### SUMMARY

A computing device that includes a display configured to display a first video and a touch strip configured to receive user input. The computing device further includes a processor and a memory storing instructions that when executed by the processor cause the processor to determine that the user input comprises a drag input defined by sliding at least one finger along the touch strip, and, in response to the drag input, cause a second video to be displayed on the display.

One advantage of embodiments of the invention is that an interface that includes a touch screen and a touch strip provide more intuitive user input mechanisms to the user.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of a computing device, according to one embodiment of the invention.

FIG. 2 is a block diagram of the hand-held device, according to one embodiment of the invention.

FIGS. 3A-3B are conceptual diagrams illustrating a user interaction with a touch screen and a touch strip that are associated with a hand-held device that is in a navigation mode, according to various embodiments of the invention.

FIG. 4 is a flow diagram of method steps for interacting with a touch screen and a touch strip that are associated with a hand-held device that is in a navigation mode, according to one embodiment of the invention.

FIGS. 5A-5C are conceptual diagrams illustrating a user interaction with a touch screen and a touch strip that are associated with a hand-held device that is in a playback mode, according to various embodiments of the invention.

FIG. 6 is a flow diagram of method steps for interacting with a touch screen and a touch strip that are associated with a hand-held device that is in a playback mode, according to one embodiment of the invention.

### DESCRIPTION OF EXAMPLE EMBODIMENTS

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring embodiments of the invention.

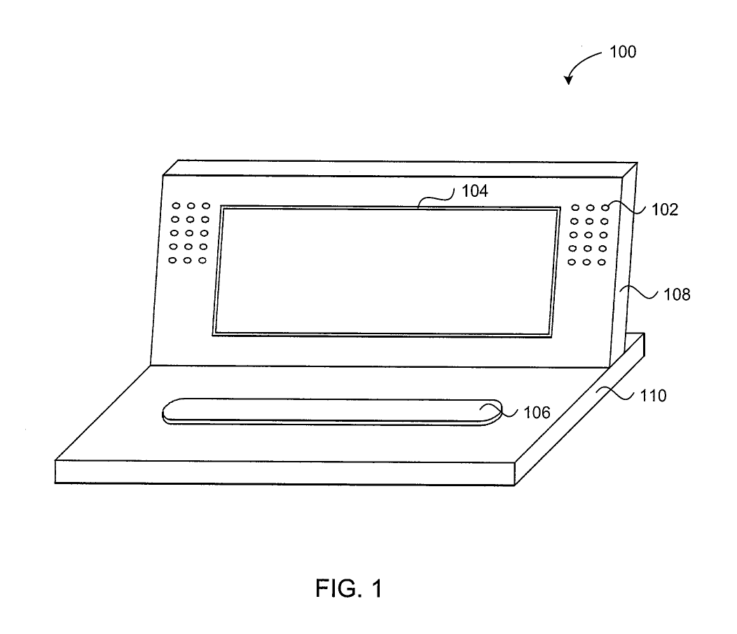

FIG. 1 is an isometric view of a computing device, according to one embodiment of the invention. In one embodiment, the computing device comprises a hand-held device (HHD) 100, as shown in FIG. 1. According to various embodiments, the HHD 100 may comprise a digital camera, a digital video camera, a digital video recorder, or other type of hand-held device. In alternative embodiments, the computing device may comprise any type of computing device, other than the HHD 100, such a personal computer, laptop, mobile phone, or the like.

As shown, the HHD 100 includes speakers 102, a touch screen 104, a touch strip 106, a cover 108, and a base 110. In one embodiment, the speakers 102 may be located to the left and the right of the touch screen 104.

In one embodiment, the touch screen 104 is implemented as a resistive touch screen. In alternative embodiments, the touch screen 104 may be implemented as a surface capacitive touch screen, a projected capacitive touch screen, or any technically feasible type of touch screen. For example, a user may activate user interface elements on the touch screen 104 using a finger or a stylus.

In some embodiments, the touch strip 106 is implemented as a capacitive-touch surface. In other embodiments, the touch strip 106 may be implemented as a resistive touch surface. In still further embodiments, the touch strip 106 is omitted from the HHD 100 and user can manipulate the user interface through the touch screen 104. As shown in the embodiment in FIG. 1, the touch strip comprises a linear strip of touch sensitive material. In alternative embodiments, the touch strip may be curved, circular, or have any other shape.

In some embodiments, the cover 108 can be positioned in one of two positions, including an upright position or a closed position. FIG. 1 illustrates the cover 108 in the upright position. In the closed position, the cover 108 lies in parallel to the base 110 and the touch strip 106 is hidden behind the cover 108. When the cover 108 is in the closed position, the user may slide the cover 108 along tracks that cause the cover 108 to be placed into the upright position. To return the cover 108 to the closed position, the user may slide the cover 108 back to the closed position along the tracks. In alternative embodiments, any technically feasible mechanism for causing the cover 108 to alternate between the upright position and the closed position may be implemented. In some embodiments, the cover 108 may not be moveable between two different positions and may be immobile. In these embodiments, the touch screen 104 and the touch strip 106 would both be implemented on the cover 108.

In one embodiment, when the cover 108 is placed in the closed position, the HHD 100 enters into a record mode. When the HHD 100 is in the record mode, the user can operate the touch screen 104 and/or the touch strip 106 to capture videos and/or photos using the HHD 100. In one embodiment, when the cover 108 is opened and placed in the upright position (as shown in FIG. 1), the HHD 100 enters a navigation mode, where the user can operate the touch screen 104 and/or the touch strip 106 to interact with and play back the videos and/or photos stored on the HHD 100.

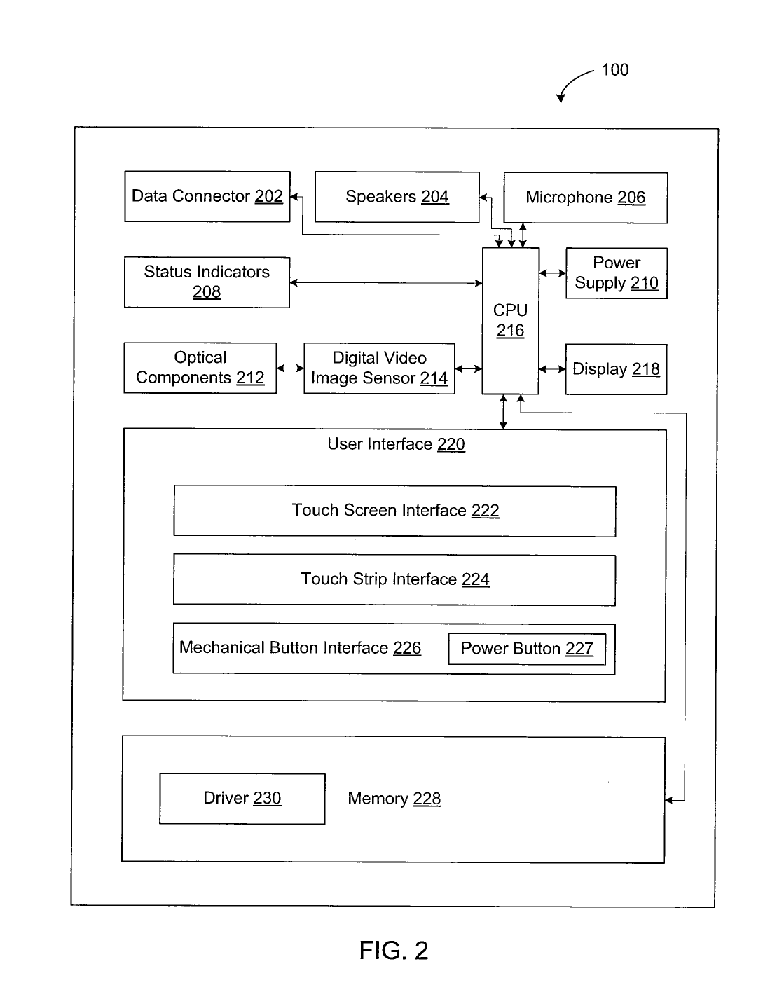

FIG. 2 is a block diagram of the HHD 100, according to one embodiment of the invention. As shown, the HHD 100 includes, without limitation, a data connector 202, a speaker 204, a microphone 206, status indicators 208, a power supply 210, optical components 212, a digital video image sensor 214, a central processing unit (CPU) 216, a display 218, a user interface 220, and an internal memory 228. In one embodiment, the HHD 100 is a digital camera, such as a digital video camera.

The data connector 202 is an integrated mechanism that allows the HHD 100 to be connected with a separate TV or computer system, such as laptop or a desktop computer, and to transfer data to and from the computer system and/or output video and audio to the TV. The data connector 202 may be a universal serial bus (USB) connector, a firewire connector, a HDMI connector, a serial connector, or another type of connector that is capable of connecting the HHD 100 with the TV or the computer system. In some embodiments, the data connector may be wireless network adapter configured to allow the HHD 100 to connect to a wireless network.

The status indicators 208 visually indicate the current mode of operation of the HHD 100. The status indicators 208 include light emitting diodes (LEDs) that can be “ON,” blinking, or “OFF,” depending on the current operating mode of the HHD 100. The operating modes of the HHD 100 include, among others, a record mode and a playback mode. When in the record mode, the HHD 100 is configured to capture video and audio of a particular scene through the optical components 212 and the microphone 206, respectively. As described above, the HHD 100 may be in record mode when the cover 108 is in the closed position.

When in the playback mode, the HHD 100 is configured to play back digital videos, photos, or other files that are stored in the internal memory 228 included in the HHD 100. The digital videos stored in the internal memory 228 may be videos captured with the HHD 100 or videos transferred to the HHD 100, but not captured by the HHD 100, including videos downloaded from the Internet. In one embodiment, the digital videos may be displayed on the display 218, and the audio may be output through the speakers 204. In alternative embodiments, the digital video and audio may be output to a TV or to a computer system for playback. In some embodiments, the display 218 comprises the touch screen 104, described in FIG. 1. For example, when the HHD 100 is in playback mode, the touch screen 104 may orient itself horizontally and allow the content stored in the internal memory 228 to be played back in full-screen mode on the touch screen 104.

The power supply 210 provides power to the HHD 100. The power may be provided by a battery or an external power source (e.g., an AC outlet). In one embodiment, the battery is a rechargeable battery that is not removable from the HHD 100. In alternative embodiments, the battery may include one or more removable and/or replaceable batteries. The optical components 212, which may include one or more lenses, capture the scene and direct light associated with the scene onto the digital video image sensor 214. The digital video image sensor 214 converts the captured light information into digital photo and/or video data and then transmits the digital photo and/or video data to the CPU 216 for further processing.

The microphone 206, similarly, captures the sound in the scene. In one embodiment, the microphone includes hardware and/or software configured to convert the captured sound to digital audio data and to transmit the digital audio data to the CPU 216 for further processing. In alternative embodiments, the microphone may transmit raw analog data to the CPU 216 without any pre-processing.

The CPU 216 communicates with the various components within the HHD 100 to control the operations of the HHD 100. The CPU may be implemented as a single chip or as a combination of multiple chips. The CPU 216 also processes inputs from the user interface 220. For example, when the HHD 100 is in record mode, the CPU 116 transmits the digital video data received from the digital video image sensor 214 to the display 218 for display. In one embodiment, the CPU 216 combines the digital audio data received from the microphone 206 and the digital video data received from the digital video image sensor 214 to create a composite video file. The composite video file may then be transmitted to the internal memory 228 for storage. When the HHD 100 is in playback mode, the CPU 216 retrieves the composite video file from the internal memory 228 and transmits the video portion of the composite video file to the display 218 and the audio portion of the composite video file to the speakers 204. In alternative embodiments, the digital audio data received from the microphone 206 and the digital video data received from the digital video image sensor 214 may be stored separately in the internal memory 228.

When the HHD 100 is in playback mode, the display 218 may be configured to display composite video files stored on the HHD 100. When the HHD 100 is in record mode, the display 218 may be configured to display an image of the scene being captured while the corresponding composite video file is being recorded.

The user interface 220 includes a touch screen interface 222, a touch strip interface 224, and/or a mechanical button interface 226. In some embodiments, the touch screen interface 222 is used to display information to the user and to process input received from the user through the touch screen 104. For example, when the HHD 100 is in playback mode, the touch screen interface 222 may provide user interface elements that allow the user to play, pause, stop, fast forward, rewind, and/or otherwise control the playback of video files on the touch screen 104. In some embodiments, the user interface elements that comprise the touch screen interface 222 may be an overlay over the video and/or photo being displayed on the touch screen 104. In some embodiments, the user may cause the user interface elements that comprise the touch screen interface 222 to be displayed and enabled by pressing-and-holding for a particular period of time anywhere on the touch screen 104 during playback. Similarly, in some embodiments, the user may cause the user interface elements that comprise the touch screen interface 222 to be not displayed and disabled by once again pressing-and-holding anywhere on the touch screen 104 during playback. In alternative embodiments, the user may cause the user interface elements that comprise the touch screen interface 222 to be displayed/enabled and/or not displayed/disable by simply pressing anywhere on the touch screen 104 during playback.

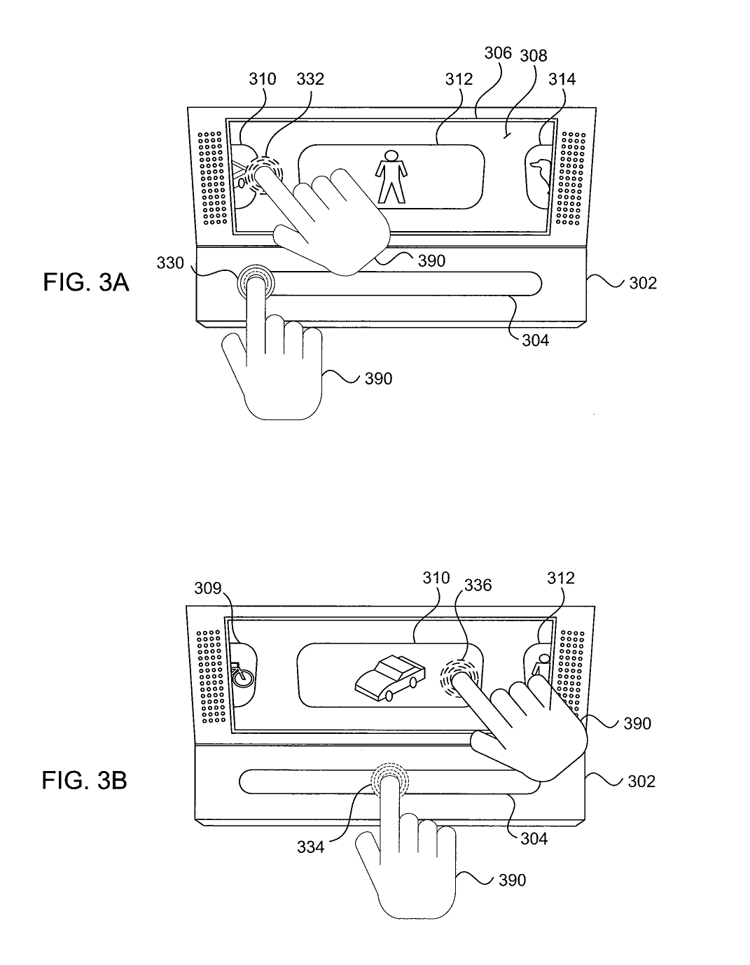

The functions provided by the touch screen interface 222 and touch screen 104 in the various operating modes of the HHD 100 are described in greater detail below in conjunction with FIGS. 3A-6.

In one embodiment, the touch strip interface 224 is used to process input received from the user through the touch strip 106. In some embodiments, the touch strip interface 224 is used primary for navigation user input associated with navigating the files stored on the HHD 110; whereas, the touch screen interface is used primarily for playback functions associated with a single video. For example, when the HHD 100 is in playback mode, the touch strip 106 can be used to scroll left and right through video thumbnails that are displayed on the touch screen 104. The scroll left and/or scroll right inputs generated by the user are received by the touch strip 106 and processed by the touch strip interface 224. The touch screen interface 222, as described above, may provide user interface elements that allow the user to play, pause, stop, fast forward, rewind, and/or otherwise control the playback of files displayed on the touch screen 104.

The mechanical button interface 226 may include a power button 227. The power button 227 is configured to turn the HHD 1000N and OFF. In some embodiments, the power button 227 is implemented as a capacitive-touch button. In alternative embodiments, the power button 227 may be implemented as an induction button, an analog-resistive button, or any other technically feasible button type that can be engaged by the user. In some embodiments, the power button may be included in the touch screen interface 222 and/or the touch strip interface 224, and the mechanical button interface 226 is omitted.

The internal memory 228 stores the composite video files as well as firmware that is executed by the CPU 216 to control the operations of the HHD 100. The internal memory 228 comprises either volatile memory, such as dynamic random access memory (DRAM), or non-volatile memory, such as a hard disk or a flash memory module, or a combination of both volatile and non-volatile memory. The internal memory 228 also stores a software driver 230 implemented as a set of program instructions configured to coordinate operation between the user interface 220 and the other components of the HHD 100, as described in greater detail herein. For example, the program instructions that constitute the driver 240 may be executed by the CPU 216 to cause different composite video file thumbnails to be displayed.

The HHD 100 provides only one example of a hand-held device, in accordance with embodiments of the invention. Any other computing devices having any number of different elements are also within the scope of embodiments of the invention.

FIGS. 3A-3B are conceptual diagrams illustrating a user interaction with a touch screen and a touch strip that are associated with a hand-held device that is in a navigation mode, according to various embodiments of the invention. FIG. 3A is a conceptual diagram that illustrates a hand-held device 302 that is similar to the HHD 100 of FIG. 1, where the hand-held device 302 includes a touch strip 304 and a touch screen 306. The touch screen 306 displays a user interface 308 when a user has activated a navigation mode of the HHD 100, according to one embodiment of the invention. In some embodiments, the navigation mode is automatically activated when the cover 108 is placed in the upright position, as described above. According to various embodiments, the navigation mode is associated with the user interface 308 displaying thumbnail representations of one or more files stored on the HHD 302 through which the user can navigate.

In one embodiment, the touch screen 306 is a resistive touch screen that is capable of identifying points of contact that are established against the touch screen 306. Such points of contact can be established by touching, for example, a stylus or a finger to the touch screen 306. According to some embodiments, the touch strip 304 is a capacitive touch surface that is capable of identifying points of contact and motion of the points of contact. Capacitive touch functionalities enable the touch strip 304 to recognize “drag” input, where a user places one or more fingers into contact with the touch strip and, while maintaining contact, drags the one or more fingers in a particular direction across the touch strip 304. Thus, the touch screen 306 effectively allows users of the HHD 100 to select user interface (UI) elements such as a previous video 310, a current video 312, and a next video 314, while the touch strip 304 effectively allows users to efficiently navigate through a plurality of UI elements, described below. Although the touch screen 306 may also be capable of recognizing drag input along the touch screen 306, the user may need to apply more pressure while making the drag input since the touch screen comprises, in some embodiments, a resistive touch screen that is less sensitive to touch.

As shown in FIG. 3A, the user interface 308 displays a current video, a previous video 310, and a next video 314. According to various embodiments of the invention, videos stored in an internal memory of the HHD 100 may be organized by folders included in a folder structure. Each folder may be associated with zero, one, or more than one video. In some embodiments, the videos in each folder are sorted according to a sorting algorithm, including, but limited to, sorted by title or date. FIG. 3A also shows a hand 390 and a contact point 332. As shown, the contact point 332 falls within the boundaries of the previous video 310 that is displayed within the user interface 308. In one embodiment, the contact point 332 is associated with a functionality that causes a processor included in the HHD 100 to set the previous video 310 as the current video.

As is also shown, the previous video 310 can also be set as the current video via input received by the touch strip 304. In some embodiments, the touch strip 304 receives input at the contact point 330, which is located at the left end of the touch strip. In some embodiments, the touch strip 304 is configured to be able to detect when a user has touched the touch strip 304 within the left end or the right end of the touch strip 304. The left end and the right end, in some embodiments, are defined by a threshold distance from the ends of the touch strip 304. In some embodiments, receiving input at the contact point 330 causes the processor to perform functionality similar to the functionality associated with the contact point 332.

In some embodiments, the previous video 310 can be set as the current video via a “drag input” received by the touch strip 304. The user can initiate a scrolling action through the videos by placing one or more fingers in contact with the touch strip 304 and sliding the one or more fingers to the left or right.

As described, various embodiments of the invention allow for up to three different techniques for a user to scroll through the videos, including (a) touching the touch screen 306 at the left or right ends of the touch screen 306, (b) touching the touch strip at the left or right ends of the touch strip 304, and/or (c) performing a drag input on the touch strip 304. According to various embodiments, one or more of the different techniques described herein for scrolling through the videos may be associated with a different action or may be disabled all together. For example, touching on the ends of the touch strip 304 may not activate the same scrolling action as touching the next/previous videos on the touch screen 306. In another example, the only way for the user to scroll through the videos is by performing the dragging input.

In other embodiments, however, the touch strip 304 may be programmed with other functionality so that receiving input at contact point 330 causes a functionality to be performed other than the functionality associated with contact point 332. For example, the contact point 330 could be associated with a functionality that causes the processor to display an options menu within the user interface 308. In some embodiments, the processor displays the options menu within the user interface 308 when the user touches the left side of the touch strip 304, as shown in FIG. 3A. In other embodiments, the processor displays the options menu within the user interface 308 when the user touches the right side of the touch strip 304. In still further embodiments, the processor displays the options menu within the user interface 308 when the user touches either the left side or the right side of the touch strip 304.

FIG. 3B is a conceptual diagram illustrating the user interface 308 that is displayed when the user navigates from the current video 312 to the previous video 310, according to one embodiment of the invention. As shown in FIG. 3A, the user has selected the previous video 310 to be set as the current video via contact point 332 or contact point 330. The processor executes a command that causes the previous video 310 to replace the current video 312 within the user interface 308. As shown, the video 310 replaces the video 312 in the user interface. Similarly, video 312 replaces the video 314 as the “next” video. In this manner, the user is able to navigate or “scroll through” the files stored on the HHD 302. In some embodiments, the replacement of previous, current, and next videos is animated and each of the next video, the current video, the previous video 310, and the new previous video slide to their respective new positions.

As shown, FIG. 3B includes the hand 390 and a contact point 336. The contact point 336 falls within the boundaries of the previous video 310 (from FIG. 3A), which is now displayed as the current video within the user interface 308. In one embodiment, the contact point 336 is associated with a functionality that causes the processor to switch the HHD 100 device into a playback mode and to execute the playback of the video 310.

According to some embodiments, the user can achieve the same functionality as achieved by contact point 336 by making contact with the touch strip 304 at contact point 334. Again, the touch strip 304 may be programmed to recognize multiple points of contact across the touch strip 304 and to perform a function that is associated with each individual point of contact. The contact point 334, for example, may be associated with a center portion of the touch strip 304. The center portion of the touch strip may be associated with a distance in either the left or right direction from the center of the touch strip.

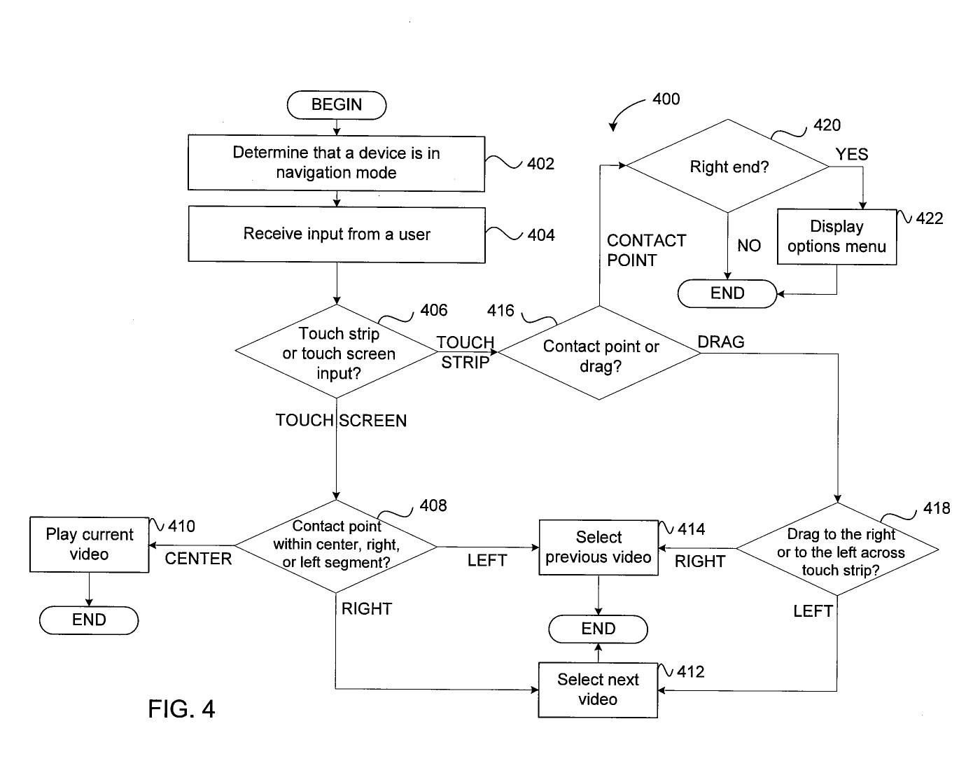

FIG. 4 is a flow diagram of method steps for interacting with a touch screen and a touch strip that are associated with a hand-held device that is in a navigation mode, according to one embodiment of the invention. Persons skilled in the art will understand that, even though the method 400 is described in conjunction with the systems of FIGS. 1-3C, any system configured to perform the method steps, in any order, is within the scope of embodiments of the invention.

As shown, the method 400 begins at step 402, where a processor included in a computing device, such as the HHD 100, determines that the computing device is in a navigation mode. In one embodiment, the navigation mode of the HHD 100 is automatically activated when the cover 108 is placed in the upright position, as described above. The navigation mode, in some embodiments, is associated with thumbnail representations of files stored in a memory included in the HHD 100 being displayed in a user interface of the HHD 100.

At step 404, the processor receives an input from a user of the HHD 100. As described herein, the HHD 100 includes a touch screen and a touch strip. The user input is received by either the touch screen or the touch strip. As described above, the user input includes establishing contact with the touch screen or touch strip using a stylus, one or more fingers, or the like.

At step 406, the processor determines whether the user input is received via the touch strip or the touch screen. In one embodiment, the processor receives input data that includes a tag that specifies the source of the input data including, but not limited to, the touch screen and/or the touch strip. Such tags enable the processor to appropriately interpret and respond to the input data. If, at step 406, the processor determines that the user input is received via the touch screen, then the method 400 proceeds to step 408.

At step 408, the processor determines whether the user input is within a center, left, or right portion of the touch screen. In one embodiment, both the touch screen and the touch strip are split into three vertically bordered portions, where the left portion is the left-most input portion defined by a threshold distance from the left end of the touch screen or touch strip, the center portion is the center-most input portion defined by a threshold distance in either the left or right direction from a center of the touch screen or touch strip, the right portion is the right-most input portion defined by a threshold distance from the right end of the touch screen or touch strip. In some embodiments, each of the left, right, and center portions have the same left-to-right length. In some embodiments, the left-to-right length of the center portion is larger than either of the left or right portions. In some embodiments, the left-to-right lengths of the left, right, and center portions are different from the touch screen relative to the touch strip.

Accordingly, the processor receives user input via the touch screen or the touch strip, determines which portion the user input falls within, and executes a functionality that is associated with the portion. If, at step 408, the processor determines that the user input is within the center portion, then the method 400 proceeds to step 410.

At step 410, the processor causes the current video to be played. The current video is the video of which a thumbnail representation is displayed in the center of the user interface. In one embodiment, the processor performs a lookup of the current video in a memory that is included in the HHD 100 and begins playback of the video. The video may be played in a full screen mode within the touch screen. The method 400 then terminates.

Referring back to step 408, if the processor determines that the user input is within the right portion, then the method 400 proceeds to step 412. At step 412, the processor of the device causes the next video to be selected. As described above, in one embodiment, the touch screen displays a user interface that includes a previous video thumbnail, a current video thumbnail, and a next video thumbnail, as illustrated in FIGS. 3A-3C. Thus, when the next video is selected, the previous video is replaced by the current video in the user interface, the current video is replaced by the next video in the user interface, and the next video is replaced by a new next video in the user interface. The method 400 then terminates.

Referring back to step 408, if the processor determines that the user input is within the left portion, then the method 400 proceeds to step 414. At step 414, the processor of the device causes the previous video to be selected. Thus, when the previous video is selected, the next video is replaced by the current video in the user interface, the current video is replaced by the previous video in the user interface, and the previous video is replaced by a new previous video in the user interface. The method 400 then terminates. In some embodiments, the functionality of steps 412 and 414 is reversed so that selecting the right portion of the touch screen causes the previous video to be selected, and selecting the left portion of the touch screen causes the next video to be selected.

Referring back to step 406, if the processor determines that the user input is received via the touch strip, then the method 400 proceeds to step 416. At step 416, the processor determines whether the input to the touch strip is a contact point input or a drag input. In one embodiment, the processor receives input information from the touch strip where the information includes a one-dimensional set of coordinates. The one-dimensional set of coordinates represents the location of the initial point of contact on the touch strip. If the location of the contact point is maintained, then input information is continually delivered to the processor. Therefore, the processor can poll the input information received in order to determine whether the input is released at the same location as the initial point of contact (i.e., a contact point input) or released at a different location than the initial point of contact (i.e., a drag input). The processor is able to determine that the input is a contact point input when the processor receives only a single instance of input information that is associated with the one-dimensional set of coordinates. In some embodiments, input information within a threshold amount of error can be considered the same input information to account for slight movements of the finger or stylus when making contact with the touch strip.

By contrast, the processor is able to determine that the input is a drag input when the contact point is held and one-dimensional set of coordinates is updated when the contact point is released.

If, at step 416, the processor determines that the input to the touch strip is a contact point input, then the method 400 proceeds to step 420. At step 420, the processor determines whether the contact point input is received at the right end of the touch strip. If the processor determines that the contact point input is not received at the right end of the touch strip (i.e., the contract point input is at the left end of the touch strip or in the center portion of the touch strip), then no action is performed and the method 400 terminates. If the processor determines that the contact point input is received at the right end of the touch strip, then the method 400 proceeds to step 422, where the processor causes an options menu to be displayed.

The options menu, when displayed, may allow the user to manipulate various functions and/or parameters of the hand-held device. Examples of functions and/or parameters that can be manipulated include, but are not limited to, display characteristics, audio settings, video sharing properties, shortcut properties, and the like.

Referring back to step 416, if the processor determines that the input to the touch strip is a drag input, then the method 400 proceeds to step 418.

At step 418, the processor determines whether the drag input travels to the right or to the left across the touch strip. As described above in step 416, one embodiment specifies that information associated with the one-dimensional set of coordinates is continually delivered to the processor when user contact is made with the touch strip. The processor can compare the received coordinates to determine whether the drag input travels to the right or to the left. If, at step 418, the processor determines that the drag input travels to the right, then the method 400 proceeds to step 414, described above. By contrast, if, at step 418, the processor determines that the drag input travels to the left, then the method 400 proceeds to step 412, also described above. In some embodiments, the functionality of steps 412 and 414 is reversed so that a drag input in the left direction causes the previous video to be selected, and a drag input in the right direction causes the next video to be selected.

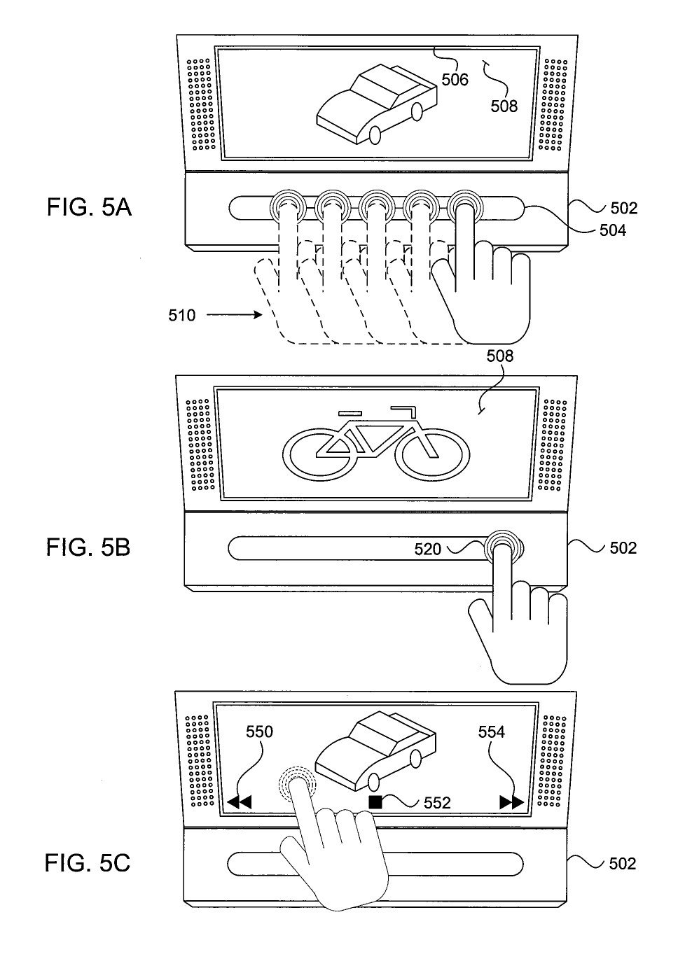

FIGS. 5A-5C are conceptual diagrams illustrating a user interaction with a touch screen and a touch strip that are associated with a hand-held device that is in a playback mode, according to various embodiments of the invention. FIG. 5A is a conceptual diagram that illustrates a hand-held device 502 that is similar to the HHD 100 of FIG. 1, where the hand-held device 502 includes a touch strip 504 and a touch screen 506. The touch screen 506 displays a user interface 508 when a user has activated the playback mode, according to one embodiment of the invention. Playback mode is associated with a video or file being played back by the HHD 502. For example, playback mode may be associated with a video being played in full screen mode. In some embodiments, the playback mode is activated when the HHD 100 is in a navigation mode and a user selects a video file for playback, as described above in FIG. 3B. In other embodiments, the playback mode is activated each time a new recording is ended and is saved to a memory included in the HHD 100.

In some embodiment, as described, the touch screen 506 may be a resistive touch screen while the touch strip 504 may be a capacitive touch surface. Capacitive touch functionalities enable the touch strip 504 to more easily recognize “drag” input. In one embodiment, a user can perform a drag input by placing one or more of his or her fingers into contact with the touch strip and, while maintaining the contact, dragging the one or more fingers in a particular direction across the touch strip 504. An example of such a drag input is illustrated as the drag input 510, where a user places his or her index finger into contact with a left side of the touch strip and, while maintaining this contact, drags his or her index finger in a left-to-right fashion across the touch strip.

In one embodiment, when the HHD 100 is in the playback mode, the user can advance to the next video or previous video via drag input to the touch strip 504. More specifically, drag input using the touch strip 504, while a video is playing on the HHD 100, causes the processor to automatically execute the playback of a next or a previous video. Thus, the user does not need to stop the current video that is playing, navigate back to the thumbnail view, scroll to the next or previous video, and select the next or previous video. Instead, the user can advance to and, in some embodiments, automatically play the next video by dragging his or her finger in a right-to-left fashion across the surface of the touch strip 504 while a video is playing. Similarly, in some embodiments, the user may advance to and automatically play the previous video by dragging his or her finger in a left-to-right fashion across the surface of the touch strip 504. Such functionality is also referred to herein as an “accelerated scroll.” According to alternative embodiments, the left-to-right and right-to-left touch strip 504 input functionalities may be inverted based on user preferences.

FIG. 5B is a conceptual diagram illustrating the user interface 508 that is displayed when the user causes a previous video to be displayed while a current video is being played, according to one embodiment of the invention. As shown in FIG. 5A, the user performs the drag input 510 while a current video is being played back. The drag input 510, as illustrated, is a left-to-right drag input which causes the processor to stop the playback of the current video, look up the previous video in a memory included in the HHD 100, and move to the previous video. As described above, a right-to-left drag input causes the processor of the HHD 100 to execute the navigation to the next video. In addition to the foregoing, contact points made to the left-most portion and right-most portion of the touch strip may be associated with functionality that matches a left-to-right drag and a right-to-left drag, respectively.

An example of such a contact point is illustrated in FIG. 5B as contact point 520, which matches the functionality of a right-to-left drag. FIG. 5C illustrates one embodiment of the response of the HHD 100 to the input of contact point 520, where the next video is selected and automatically played back to the user. Thus, the user can accomplish the same playback functionality, i.e., the accelerated scroll, through multiple techniques of input, which advantageously increases the intuitive input options associated with the HHD 100. As shown in the sequence of FIGS. 5A-5C, a video of a car is being displayed in FIG. 5A when an accelerated scroll input is received via a left-to-right drag input, which causes the previous video to be displayed. The previous video, representing a bicycle, is shown being played back in FIG. 5B, when an accelerated scroll input is received via a contact point input with a right portion of the touch strip, which causes the next video to be displayed. As shown in FIG. 5C, the next video, which is the same video as shown in FIG. 5A, is displayed after the contact point input is received in FIG. 5B.

According to various embodiments and as described above, the “accelerated scroll” features described in FIGS. 5A-5B causes the next/previous video to be displayed. In one embodiment, performing the accelerated scroll causes the next/previous video to be automatically played back in full screen mode. In an alternative embodiment, performing the accelerated scroll causes the next/previous video to be automatically displayed in a paused state. In still further embodiments, performing the accelerated scroll causes the hand-held device to return to the navigation mode and display a representation (e.g., a thumbnail) of the next/previous video set as the current video in the center of the user interface.

FIG. 5C also shows the user interface 508 that is displayed when contact is established with the touch screen 506 while the HHD 100 is in the playback mode, according to one embodiment of the invention. In one embodiment, when the playback of a video is being executed by the processor, the user interface 508 displays the video in a full screen mode where no UI elements are included within the user interface 508, as shown in FIGS. 5A-5B. In one embodiment, if, during playback mode, the user establishes a press-and-hold contact with the touch screen 508 anywhere within the boundaries of the touch screen 508, then the processor causes the touch screen 508 to display a playback control menu that overlays the playback of the current video. In one embodiment, the playback control menu includes a rewind button 550, a stop button 552, and a fast forward button 554. In other embodiments, the playback control menu includes any technically feasible control capability, including pause control, volume control, or the like. Functionality that is associated with each playback control menu button is executed when the user establishes a point of contact against the touch screen 508 and where the point of contact falls within the boundaries associated with a particular button. In addition, if the user desires to hide the playback control menu, then the user may once again establish a press-and-hold contact against the touch screen 508 where the point of contact falls outside of the boundaries associated with any control menu buttons that are included in the playback control menu. In some embodiments, the center of the touch screen is not associated with any control menu buttons. Therefore, touching the screen in the center causes the control menu buttons to be hidden. In alternative embodiments, the user may cause the playback control menu to be displayed/enabled and/or hidden/disabled by simply establishing a touch contact with the touch screen, where the touch contact is not a press-and-hold contact.

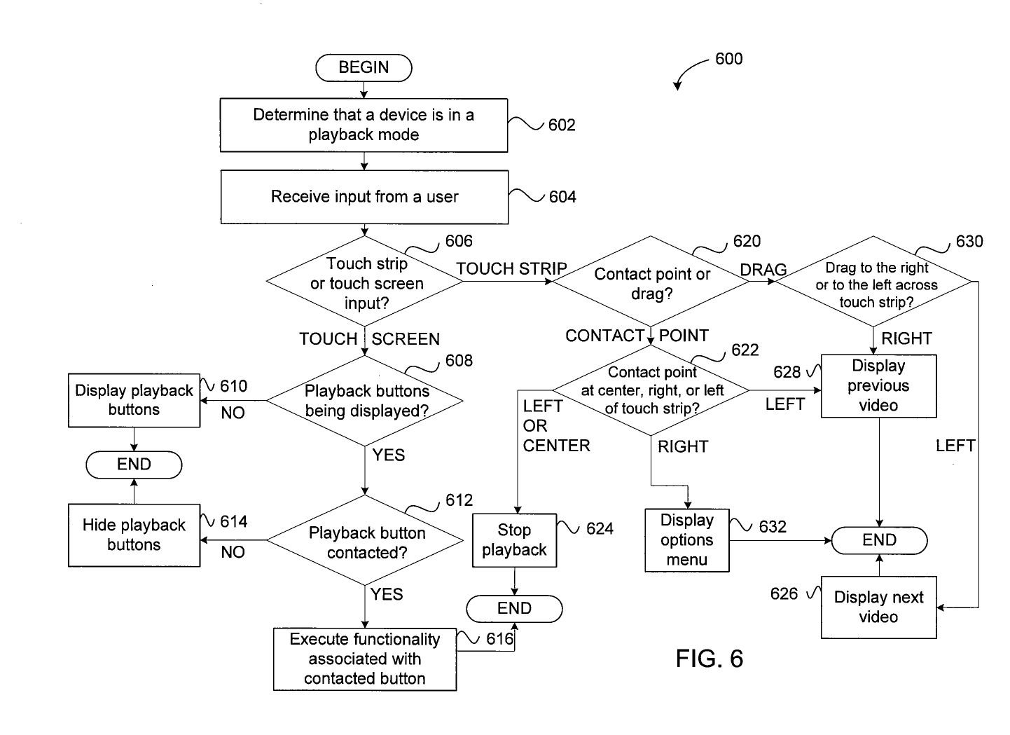

FIG. 6 is a flow diagram of method steps for interacting with a touch screen and a touch strip that are associated with a hand-held device that is in a playback mode, according to one embodiment of the invention. Persons skilled in the art will understand that, even though the method 600 is described in conjunction with the systems of FIGS. 1-3B and 5A-5C, any system configured to perform the method steps, in any order, is within the scope of embodiments of the invention.

As shown, the method 600 begins at step 602, where a processor included in a computing device, such as the HHD 100, determines that the computing device is in a playback mode. In some embodiments, the playback mode is associated with a video or file being played back by the HHD 100. In one embodiment, the playback mode of the HHD 100 is activated when the HHD 100 is in a navigation mode and a user selects a video file for playback, as described above in FIG. 3B.

At step 604, the processor receives an input from a user of the HHD 100. The user input is received by either a touch screen or a touch strip that is associated with the HHD 100. As described above, such user input includes establishing contact with the touch screen or touch strip using a stylus, one or more fingers, or the like.

At step 606, the processor determines whether the touch strip or the touch screen receives the user input. In one embodiment, the processor receives input data that includes a tag that specifies the source of the input data including, but not limited to, the touch screen and/or the touch strip. Such tags enable the processor to appropriately interpret and respond to the input data. If, at step 606, the processor determines that the touch screen receives the user input of press-and-hold, then the method 600 proceeds to step 608.

At step 608, the processor determines whether video playback buttons are currently being displayed on a touch screen included in the computing device. In one embodiment, the processor references a Boolean value that is stored in a memory that is included in the HHD 100, where the Boolean value is TRUE when the video playback buttons are being displayed, and where the Boolean value is FALSE value when the video playback buttons are not being displayed. If, at step 608, the processor determines that the video playback buttons are not being displayed on the touch screen, then the method 600 proceeds to step 610.

At step 610, the processor causes video playback buttons to be displayed on the touch screen. The Boolean value discussed in step 608 is accordingly updated to a TRUE value that accurately reflects the updated display state of the video playback buttons. In one embodiment, the video payback buttons overlay the video being played back on the touch screen and include, but are not limited to, common playback buttons such as rewind, stop, pause, play, fast forward, or the like. The method 600 then terminates.

Referring back to step 608, if the processor determines that the video playback buttons are currently being displayed on the touch screen, then the method 600 proceeds to step 612.

At step 612, the processor determines whether the input to the touch screen makes contact with any of the video playback buttons. In one embodiment, an (x,y) coordinate value associated with the point of contact is transmitted to the processor for determination of whether any of the buttons has been contacted. If the processor determines that the input makes contact with one of the video playback buttons, then the method proceeds to step 616. At step 616, the processor executes functionality associated with the contacted button. For example, the processor may determine that the (x,y) coordinate falls inside of the boundaries associated with a rewind button that is included in the video playback buttons that overlay the video being played back on the screen. Thus, the processor executes a rewind of the video being played back on the touch screen. The method 600 then terminates.

Referring back to step 612, if the processor determines that the input makes contact with none of the video playback buttons, then the method proceeds to step 614. At step 614, the processor causes the video playback buttons to be hidden and to no longer be displayed on the user interface.

As described above at step 608, in some embodiments, the user enters a press-and-hold contact with the touch screen in order to cause the playback buttons to be displayed. In alternative embodiments, any contact with the touch screen, such as a touch contact, causes the playback buttons to be displayed/enabled and/or hidden/disabled. In still further embodiments, a press-and-hold contact with touch screen input causes the playback buttons to be displayed/enabled and/or hidden/disabled, and a touch contact with the touch screen causes the hand-held device to stop playback of the current video return to navigation mode.

Referring back to step 606, if the processor determines that the touch strip receives the user input, then the method 600 proceeds to step 620. At step 620, the processor determines whether the touch strip input is a contact point input or a drag input using techniques described above in step 416 of FIG. 4. If, at step 620, the processor determines that the touch strip input is a contact point input, then the method 600 proceeds to step 622.

At step 622, the processor determines whether the contact point is at a center portion, a right portion, or a left portion of the touch strip, using techniques described above in step 408 of FIG. 4. If, at step 622, the processor determines that the contact point is at the left or center portion of the touch strip, then the method 600 proceeds to step 624. At step 624, the processor stops the playback of the video. In one embodiment, when the playback of the video is stopped, the HHD 100 returns to the navigation mode. The method 600 then terminates.

If, at step 622, the processor determines that the contact point is at the right portion of the touch strip, then the method 600 proceeds to step 632, where the processor causes an options menu to be displayed. The options menu, when displayed, may allow the user to manipulate various functions and/or parameters of the hand-held device. Examples of functions and/or parameters that can be manipulated include, but are not limited to, display characteristics, audio settings, video sharing properties, shortcut properties, and the like.

Referring back to step 620, if the processor determines that the touch strip input is a drag input, then the method 600 proceeds to step 630. At step 630, the processor determines whether the drag input travels to the right or to the left across the touch strip using techniques described above in step 418 of FIG. 4. If, at step 630, the processor determines that the drag input travels to the right across the touch strip, then the method 600 proceeds to step 628.

At step 628, the processor causes the previous video to be displayed. In one embodiment, the processor performs a look up of a previous video in the memory included in the HHD 100 to display the previous video. Accordingly, the input received at step 630 is associated with an “accelerated scroll,” as described above. According to various embodiments, the “accelerated scroll” feature described in FIGS. 5A-5B causes the next/previous video to be displayed. In one embodiment, performing the accelerated scroll causes the next/previous video to be automatically played back in full screen mode. In an alternative embodiment, performing the accelerated scroll causes the next/previous video to be automatically displayed in a paused state. In still further embodiments, performing the accelerated scroll causes the hand-held device to return to the navigation mode and display a representation (e.g., a thumbnail) of the next/previous video set as the current video in the center of the user interface. The method 600 then terminates.

By contrast, if, at step 630, the processor determines that the drag input travels to the left across the touch strip, then the method 600 proceeds to step 626. At step 626, the processor causes the next video to be displayed. In some embodiments, step 626 is substantially similar to step 628, but involves the next video rather than the previous video.

In sum, embodiments of the invention provide a technique for navigating the features of a computing device via input to a touch screen and/or a touch strip. The touch screen may be a resistive touch surface, where a user can tap a particular part of the touch screen using a stylus, one or more fingers, or the like. The touch strip may be one-dimensional a capacitive touch input surface, where a user can drag one or more fingers across the touch strip. According to various embodiments, user inputs received via the touch screen may be primarily associated with playback functionality, such as causing a video to played or accessing control functions, such as fast-forward, rewind, or the like. In contrast, user inputs received via the touch strip may be primarily associated with navigation functionality, such as scrolling trough or browsing the video files stored on the device.

One advantage of embodiments of the invention is that an interface that includes a touch screen and a touch strip provide more intuitive user input mechanisms to the user. Another advantage is that including a resistive touch screen and a capacitive touch strip reduces the overall manufacturing cost that is typically associated with capacitive touch screens, while maintaining functionality associated with capacitive touch screens.

While the forgoing is directed to embodiments of the invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the invention, are embodiments of the invention. Therefore, the scope of the invention is determined by the claims that follow.

What is claimed is:

1. A computing device, comprising:
a display configured to display a first video;
a touch strip configured to receive user input;
a processor; and
a memory storing instructions that when executed by the processor cause the processor to:
determine that the user input comprises a drag input defined by sliding at least one finger along the touch strip, and
in response to the drag input, cause a second video to be displayed on the display.

2. The computing device of claim 1, wherein the computing device comprises a digital video camera.

3. The computing device of claim 1, wherein the first video and the second video are displayed in a full screen mode on the display.

4. The computing device of claim 1, wherein the display comprises a touch screen configured to receive user input via the touch screen.

5. The computing device of claim 4, wherein the touch screen comprises a resistive touch screen, and the touch strip comprises a capacitive touch strip.

6. The computing device of claim 1, wherein the touch strip comprises at least one of a linear touch strip or a curved touch strip.

7. The computing device of claim 1, wherein the drag input comprises left-to-right drag motion along the touch strip, the first video comprises a current video included in a folder, and the second video comprises a previous video included in the folder.

8. The computing device of claim 1, wherein the drag input comprises right-to-left drag motion along the touch strip, the first video comprises a current video included in a folder, and the second video comprises a next video included in the folder.

9. The computing device of claim 1, wherein the touch strip is included in a base portion of the computing device, and the touch screen is included in a cover portion of the computing device.

10. The computing device of claim 9, wherein the touch strip is hidden when the cover portion is parallel to the base portion.

11. The computing device of claim 9, wherein the touch strip is exposed when the cover portion is placed in an upright position and is not parallel to the base portion.

12. A method, comprising:
causing a first video to be displayed on a display associated with a computing device that includes a touch strip;
receiving user input via a touch strip;
determining that the user input comprises a drag input defined by sliding at least one finger along the touch strip; and
in response to the drag input, causing a second video to be displayed on the display.

13. The method of claim 12, wherein the first video and the second video are displayed on the display in full screen mode.

14. The method of claim 12, wherein the second video is displayed on the display in a paused state.

15. The method of claim 12, wherein causing the second video to be displayed comprises returning to a navigation mode and causing a representation of the second video to be displayed on the display within the navigation mode.

16. The method of claim 1, wherein the display comprises a touch screen configured to receive user input via the touch screen.

17. A computer-readable storage medium storing instructions that, when executed by a processor, cause the processor to manipulate one or more files, by performing the steps of:
causing a first video to be displayed on a display associated with a computing device that includes a touch strip;
receiving user input via a touch strip;
determining that the user input comprises a drag input defined by sliding at least one finger along the touch strip; and
in response to the drag input, causing a second video to be displayed on the display.

18. The computer-readable storage medium of claim 17, wherein the first video and the second video are displayed on the display in full screen mode.

19. The computer-readable storage medium of claim 17, wherein the second video is displayed on the display in a paused state.

20. The computer-readable storage medium of claim 17, wherein causing the second video to be displayed comprises returning to a navigation mode and causing a representation of the second video to be displayed on the display within the navigation mode.
